(19) United States
(12) Patent Application Publication
(10) Pub. No.: US 2021/0197275 A1
(43) Pub. Date: Jul. 1, 2021

(54) THREE DIMENSIONAL PRINTING SYSTEM AND METHOD CAPABLE OF CONTROLLING SIZE OF MOLTEN POOL FORMED DURING PRINTING PROCESS

(71) Applicant: Korea Advanced Institute of Science and Technology, Daejeon (KR)

(72) Inventors: Hoon SOHN, Daejeon (KR); Ikgeun JEON, Daejeon (KR)

(73) Assignee: Korea Advanced Institute of Science and Technology, Daejeon (KR)

(21) Appl. No.: 17/118,862

(22) Filed: Dec. 11, 2020

(30) Foreign Application Priority Data
Dec. 31, 2019 (KR) 10-2019-0179191

(51) Int. Cl. B22F 10/25; B22F 10/85; B22F 12/90; B22F 12/41; G06T 7/50; G06T 7/62; G06T 7/00; B23K 26/70; B23K 26/067; B23K 26/06; B22F 10/368

(52) U.S. Cl. CPC B22F 10/25; B33Y 10/00; B22F 12/90; B22F 12/41; G06T 7/50; G06T 7/62; G06T 7/0004; B23K 26/705; B23K 26/067; B23K 26/0648; B22F 10/368; B22F 2203/11; G06T 2207/20081; G06T 2207/20084; G06T 2207/30164; B22F 10/85

(57) ABSTRACT

Disclosed are a method of controlling a size of a molten pool formed during a 3D printing process in real time and a system for the same. A thermal image of the molten pool is taken by a thermal imaging camera. A temperature interface exceeding a melting point of a base metal is specified in the thermal image. A size of the molten pool is obtained by estimating a length, a width, and a depth of the molten pool using the temperature interface. A predicted size of the molten pool is obtained using an artificial neural network model. An actually measured size of the molten pool is derived from a surface temperature of the molten pool. An error between the predicted size and the measured size of the molten pool is calculated to be used for controlling the size of the molten pool in real time.

### CROSS-REFERENCE TO RELATED APPLICATION

This U.S. non-provisional application claims priority under 35 USC § 119 from Korean Patent Application No. 10-2019-0179191, filed on Dec. 31, 2019 in the Korean Intellectual Property Office (KIPO), the disclosure of which is hereby incorporated by reference in its entirety.

### BACKGROUND

### 1. Technical Field

The present disclosure relates to a three-dimensional (3D) printing, and more particularly, to a 3D printing system and method capable of controlling the size of a molten pool formed during a 3D printing process.

### 2. Description of the Related Art

The 3D printing is known as a manufacturing technology for producing a 3D object. For the 3D printing of the 3D object, it is processed in a way that stacks layer by layer based on the 3D model data processing information. The 3D printing technology has advantages that facilitate realization of a complex shape, a shape formed inside a product, etc. Due to these advantages, the 3D printing technology is in the spotlight as a high value-added technology that makes it easy to manufacture various products such as various industrial parts and medical materials.

The 3D printing process can be performed by dividing the shape of a 3D product into a number of 2D cross sections having a uniform or variable thickness, and forming the 2D cross sections to be stacked one by one. There are several known 3D printing methods such as a material extrusion method, a material jetting method, a binder jetting method, a sheet lamination method, a vat photo-polymerization method, a powder bed fusion method, a directed energy deposition (DED) method, etc. Among them, the DED method is a method of applying laser energy to metal powder or wire material to be melted and fused, and is widely used because of its advantages that it can use inexpensive commercial materials compared to other methods, form a lamination on existing 3D shapes, and have superior mechanical properties compared to other methods.

In the 3D printing according to the DED method, a molten pool is formed when a laser beam irradiated from a laser source is irradiated to the substrate, and metal powder is supplied onto the molten pool to form a lamination. In the 3D processing, the size of the molten pool such as the length, width, and depth of the molten pool generated in the base material is an important factor in determining the lamination quality of the 3D printing. Controlling the size of the molten pool is a necessary technique to improve the lamination quality. However, a technology for controlling the size of the molten pool in real time has not been developed yet.

### SUMMARY

The present disclosure has been made under the recognition of the above-mentioned problems of the conventional art. Some embodiments of the present disclosure are to provide a 3D printing system and method capable of controlling the size of a molten pool generated on the base material in real time during a 3D printing process.

In one aspect, some embodiments of the present disclosure provide a method of controlling a size of a molten pool formed during a 3D printing process in real time. The method includes: taking a thermal image of the molten pool formed during the 3D printing process with a thermal imaging camera; specifying a temperature interface exceeding a melting point of a base metal in the thermal image representing a surface temperature of the molten pool; obtaining a size of the molten pool by estimating a length, a width, and a depth of the molten pool using the temperature interface; constructing an artificial neural network model configured to predict a size of the molten pool according to input values of process variables by machine-learning correlation between the process parameters for 3D printing, including intensity of laser beam, process speed, size of the laser beam, and ejection amount of the base material, and the size of the molten pool including length, width, and depth of the molten pool; deriving, using the artificial neural network model, a predicted value of the size of the molten pool corresponding to the values of process variables currently applied in the currently measured thermal image; deriving a measured value of a size of an actual molten pool from a surface temperature of the molten pool currently measured by using the thermal imaging camera; calculating an error between the predicted value of the size of the molten pool using the artificial neural network model and the measured value of the size of the actual molten pool; and controlling the size of the molten pool in real time by adjusting the values of the processing variables so that the calculated error does not exceed a tolerance threshold.

In an embodiment, the process variables whose values may be adjusted in the ‘controlling the size of the molten pool’ are automatically selected based on a correlation between the process variables acquired by the machine-learning and the size of the molten pool.

In an embodiment, the controlling the size of the molten pool by adjusting the values of the process variables may be repeatedly performed until the error does not exceed the tolerance threshold.

In an embodiment, the depth of the molten pool may be estimated based on the length and width of the molten pool.

In an embodiment, the estimated maximum depth (d) of the molten pool may be determined by a z-axis coordinate value (Zmax) at a point (Xmax, 0, Zmax) where a derivative in length direction of a temperature relation, Φ=T(x, y=0, z)−Tm, of the molten pool is 0, where T(x, y=0, z) is a temperature of the molten pool when assuming that the maximum depth (d) point of the molten pool is located at a center (y=0) in a width direction (y-axis direction) of the molten pool.

In an embodiment, the ‘controlling the size of the molten pool’ may include detecting abnormal quality based on whether the calculated error exceeds the tolerance threshold; feed-backing the calculated error in real-time when abnormal quality is detected; and adjusting the process variables of 3D printing through the real-time feedback.

In an embodiment, the 3D printing process may be a 3D printing process based on direct energy deposition (DED) method.

In an embodiment, the base material of the molten pool may be a metal material.

In another aspect, some embodiments of the present disclosure provide a 3D printing system including a laser source, a base material supply source, a thermal imaging camera, and a control unit. The laser source is configured to form a molten pool in a laminated 3D object by irradiating a laser beam to melt the base material supplied to the laminated 3D object. The base material supply source is configured to supply a base material to the laminated 3D object. The thermal imaging camera is configured to take a thermal image of the molten pool to measure a surface temperature of the molten pool. The control unit is configured to control a size of the molten pool formed during a 3D printing process in real time. The control unit includes the functions of taking a thermal image of the molten pool formed during the 3D printing process with a thermal imaging camera; specifying a temperature interface exceeding a melting point of a base metal in the thermal image representing a surface temperature of the molten pool; obtaining a size of the molten pool by estimating a length, a width, and a depth of the molten pool using the temperature interface; constructing an artificial neural network model configured to predict a size of the molten pool according to input values of process variables by machine-learning correlation between the process parameters for 3D printing, including intensity of laser beam, process speed, size of the laser beam, and ejection amount of the base material, and the size of the molten pool including length, width, and depth of the molten pool; deriving, using the artificial neural network model, a predicted value of the size of the molten pool corresponding to the values of process variables currently applied in the currently measured thermal image; deriving a measured value of a size of an actual molten pool from a surface temperature of the molten pool currently measured by using the thermal imaging camera; calculating an error between the predicted value of the size of the molten pool using the artificial neural network model and the measured value of the size of the actual molten pool; and controlling the size of the molten pool in real time by adjusting the values of the processing variables so that the calculated error does not exceed a tolerance threshold.

In an embodiment, the thermal imaging camera may be disposed such that at least a part of an optical path of the thermal imaging camera is coaxially with a laser beam irradiated from the laser source that melts a base material supplied to the laminated printing object.

In an embodiment, the system may further include a beam splitter disposed on a beam path irradiated from the laser source; and an optical path converter disposed between the beam splitter and the thermal imaging camera to change a path of light, wherein the thermal imaging camera is disposed coaxially with the laser source.

In an embodiment, the beam splitter may be disposed between the laser source and a focus lens through which laser beam emitted from the laser source passes.

In an embodiment, the depth of the molten pool may be estimated from the obtained length and width of the molten pool.

In an embodiment, the estimated maximum depth (d) of the molten pool may be determined by a z-axis coordinate value (Zmax) at a point (Xmax, 0, Zmax) where a derivative in length direction of a temperature relation, Φ=T(x, y=0, z)−Tm, of the molten pool is 0, where T(x, y=0, z) is a temperature of the molten pool when assuming that the maximum depth (d) point of the molten pool is located at a center (y=0) in a width direction (y-axis direction) of the molten pool.

In an embodiment, the control unit may automatically select process variables to be adjusted so that the calculated error does not exceed the tolerance threshold based on the correlation between the process variables learned by the machine learning and the size of the molten pool.

In an embodiment, the control unit may repeatedly perform controlling the size of the molten pool by adjusting values of the process variables until the calculated error does not exceed the tolerance threshold.

According to embodiments of the present disclosure, the size of the molten pool is estimated by using a thermal imaging camera to estimate the size of the molten pool formed during the 3D printing process, and by analyzing the correlation between the process variable used for 3D printing and the size of the molten pool. You can control the size in real time.

In addition, according to an embodiment of the present disclosure, after analyzing the correlation between the process variable used for 3D printing and the size of the molten pool during the 3D printing process, an artificial neural network is constructed. A size of the molten pool can be predicted using the artificial neural network model. The quality abnormality of the molten pool can be easily determined by comparing the predicted size with the measured size of the actual molten pool.

In addition, according to the embodiments of the present disclosure, when a quality error is detected during the 3D printing process, the size of the molten pool may be controlled in real time by adjusting the 3D printing process variable.

According to the embodiments of the present disclosure, since the process control is performed in real time while adjusting 3D printing process variables, quality of parts and process efficiency can be increased.

### BRIEF DESCRIPTION OF THE DRAWINGS

Illustrative, non-limiting example embodiments will be more clearly understood from the following detailed description taken in conjunction with the accompanying drawings.

FIG. 1 is a configuration diagram of a 3D printing system according to an example embodiment of the present disclosure.

FIG. 2 is a flow chart showing a method of controlling the size of a molten pool in a 3D printing system according to an embodiment of the present disclosure.

FIG. 3 is a flow chart showing detailed steps of extracting the size of the molten pool in the method of controlling the size of the molten pool in the 3D printing system according to an embodiment of the present disclosure.

FIG. 4 is a flow chart showing detailed steps of calculating an error between a size of the molten pool predicted by using an artificial neural network model and a size of the molten pool actually measured in the 3D printing system according to an embodiment of the present disclosure.

FIG. 5 is a flow chart showing detailed steps of controlling the size of the molten pool based on the error between the predicted size and the measured size of the molten pool in the 3D printing system according to an embodiment of the present disclosure.

FIG. 6A is a model for predicting a molten pool temperature distribution, which is a schematic diagram showing the length, width, and depth of a molten pool formed on a base material, and FIGS. 6B and 6C are views showing cross-sectional and plan views of the molten pool.

FIG. 7A is a view showing a coordinate system for obtaining a boundary surface of the molten pool formed on the base material, and FIG. 7B is a view showing a coordinate corresponding to the depth of the molten pool in a cross-sectional view of the molten pool.

FIG. 8 is a schematic diagram of extracting features of the molten pool by measuring the molten pool.

FIG. 9 is a schematic diagram for analyzing a correlation between process variables and sizes of molten pools using machine learning.

FIG. 10 is a diagram illustrating a real-time monitoring process through error analysis between a predicted value of size and a measured value of size.

FIG. 11 is a diagram illustrating a process of controlling process variables through feedback control when quality abnormality is detected.

### DETAILED DESCRIPTION OF THE EMBODIMENTS

Hereinafter, embodiments of the present disclosure will be described in detail with reference to the accompanying drawings. The present disclosure may be implemented in various different forms, and is not limited to the embodiments described herein. In the drawings, parts irrelevant to the description are omitted in order to clearly describe the present disclosure, and the same reference numerals are assigned to the same or similar elements throughout the specification.

The 3D printing system according to an embodiment of the present disclosure is a system capable of melting a base material using a laser to form a three-dimensional object, and also estimating the temperature of the molten pool melted during the 3D printing process in real time. In this case, the 3D printing system according to an embodiment of the present disclosure may be a DED type 3D printing system capable of forming a 3D object by melting metal powder or metal wire with a laser.

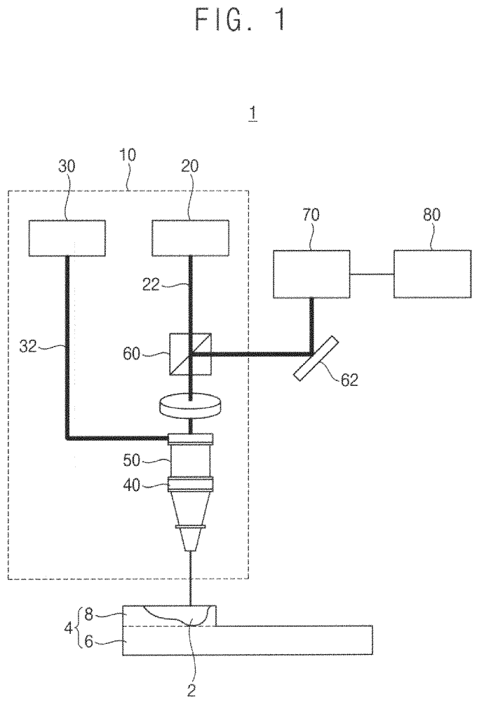

FIG. 1 illustrates a configuration of a 3D printing system according to an embodiment of the present disclosure.

Referring to FIG. 1, in an example embodiment the 3D printing system 1 may include a laser source 20 for 3D printing, a base material supply source 30, a focus lens 40, a nozzle 50, and a thermal imaging camera 70 and a control unit 80.

In an example embodiment, the laser source 20 may irradiate a laser beam 22 to a laminated printing object 4. The laser beam 22 irradiated from the laser source 20 passes through the focus lens 40 and is incident on the laminated printing object 4. The laser beam 22 irradiated from the laser source 20 may pass through the nozzle 50 for supplying the base material while the laser beam 22 reaches a molten pool 2.

In an example embodiment, the base material supplied from the base material supply source 30 may be fed to the nozzle 50 in the form of, for example, metal powder or metal wire through a separate supply pipe 32. To supply the base material to the laminated printing object 4, the movement path of the base material in the nozzle 50 may be formed to be parallel to or oblique to the path through which the laser beam 22 passes. The base material supplied to the laminated printing object 4 may be melted by the laser source 20 to form the molten pool 2 in the laminated printing object 4.

The laminated printing object 4 may be formed as a three-dimensional object by laminating a plurality of layers. In FIG. 1, illustrated is an example state where the laminated printing object 4 is formed of, for example, a first layer 6 and a second layer 8, and the molten pool 2 is formed on the second layer 8.

In the 3D printing system 1 according to an embodiment of the present disclosure, the laser source 20, the base material supply source 30 and the supply pipe 32, the focus lens 40 and the nozzle 50 may form a general DED type 3D printer 10. The 3D printer 10 that can be applied to the 3D printing system 1 according to the example embodiment of the present disclosure is not limited to the DED type 3D printer. If any 3D printer can form the molten pool 2 using metal as the base material, it can be applied to the 3D printing system 1.

In the 3D printing system 1, a thermal imaging camera 70 may be provided to measure the surface temperature of the molten pool 2 formed in the laminated printing object 4.

In order to measure the surface temperature of the molten pool 2 with the thermal imaging camera 70, a beam splitter 60 may be installed between the laser source 20 and the focusing lens 40.

The beam splitter 60 may be disposed on a path through which the laser beam 22 irradiated from the laser source 20 travels to the molten pool 2 and change the path of light reflected from the molten pool 2. The light changed by the beam splitter 60 may pass through an optical path converter 62 and be photographed by the thermal imaging camera 70. The optical path converter 62 that converts the optical path may be, for example, a reflecting mirror. Accordingly, the thermal imaging camera 70 can measure the surface temperature of the molten pool 2.

In an example embodiment, the thermal imaging camera 70 may be disposed coaxially with the nozzle 50 for irradiating laser light. Since the thermal imaging camera 70 is installed coaxially with the nozzle 50 of the 3D printer, it is possible to continuously photograph the laminated printing object 4 without controlling the position of the thermal imaging camera 70.

In an example embodiment, the thermal imaging camera 70 may be installed in the 3D printer together with the optical path converter 62 and the beam splitter 60 to measure the surface temperature of the molten pool 2 of the 3D printer.

In the 3D printing system 1 according to an example embodiment, the control unit 80 may be provided to estimate the depth of the molten pool 2 by using the surface temperature of the molten pool 2 measured by the thermal imaging camera 70.

Hereinafter, a method of controlling a size of the molten pool 2 using the control unit 80 of the 3D printing system 1 will be described with reference to different drawings.

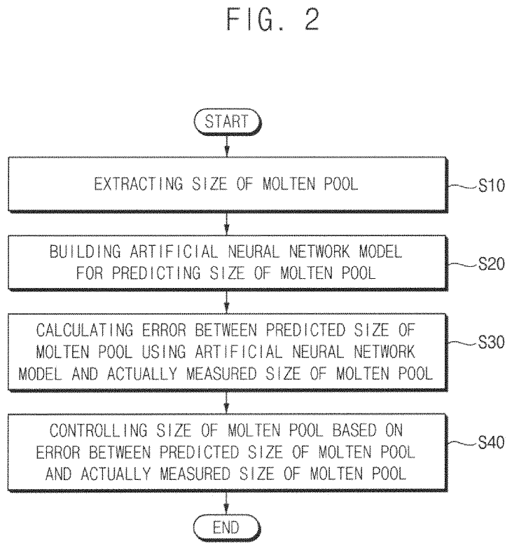

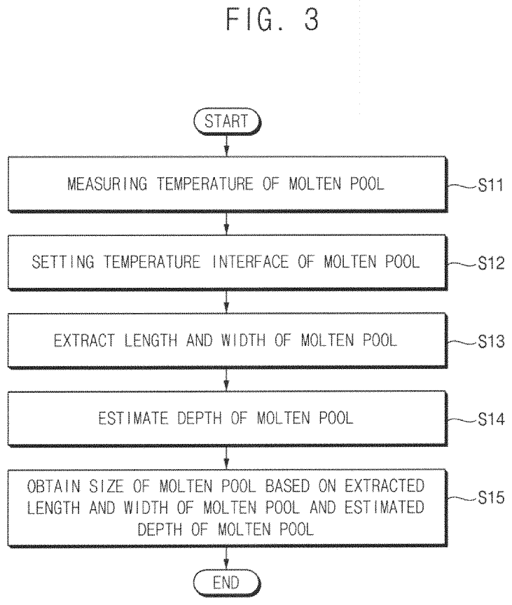

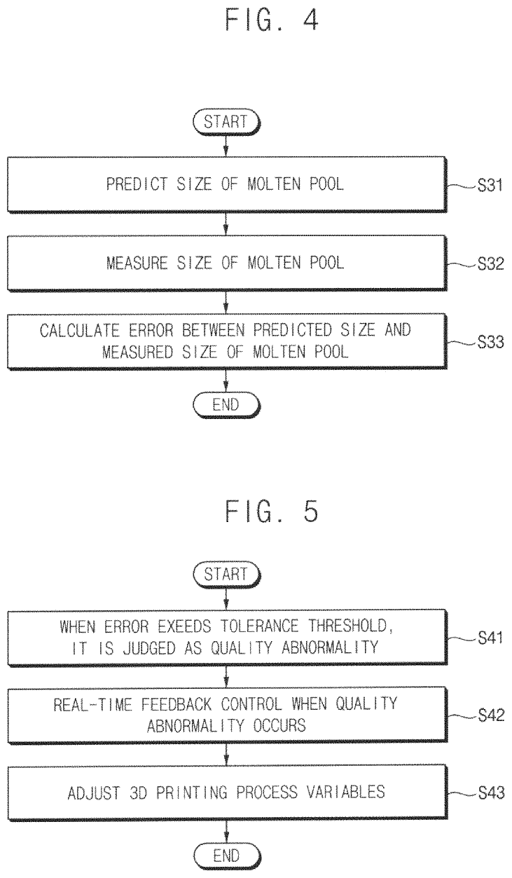

FIG. 2 is a flow chart showing the method of controlling the size of the molten pool in a 3D printing system according to an example embodiment. FIG. 3 is a flow chart showing detailed procedure of extracting the size of the molten pool according to an example embodiment. FIG. 4 is a flow chart showing detailed procedure of calculating an error between a predicted size of the molten pool based on an artificial neural network model and an actually measured size of the molten pool according to an example embodiment. FIG. 5 is a flow chart showing detailed procedure of controlling the size of the molten pool based on the error between the predicted size and the measured size of the molten pool according to an example embodiment.

With reference to FIG. 2, the method of controlling the size of a molten pool 2 formed during the 3D printing process may include the steps of extracting a size of the molten pool 2 (S10), building an artificial neural network model for predicting the size of the molten pool 2 (S20), calculating an error between a predicted size of the molten pool 2 using the artificial neural network model and an actually measured size of the molten pool 2 (S30), and controlling the size of the molten pool 2 based on an error between the predicted size of the molten pool and the actually measured size of the molten pool 2 (S40).

Referring to FIG. 3, the step (S10) of extracting the size of the molten pool 2 may include measuring a temperature of the molten pool 2 (S11), and setting a temperature boundary surface, that is, a temperature interface of the molten pool 2 (S12).

In an example embodiment, the step (S11) of measuring the temperature of the molten pool 2 may include measuring a surface temperature of the molten pool 2 using the thermal imaging camera 70 of the 3D printing system 1.

In the embodiment, the control unit 80 may set the temperature interface 3 that exceeds a melting point of the base material from the measured temperature image (S12) and extract a length and a width of the molten pool 2 (S13).

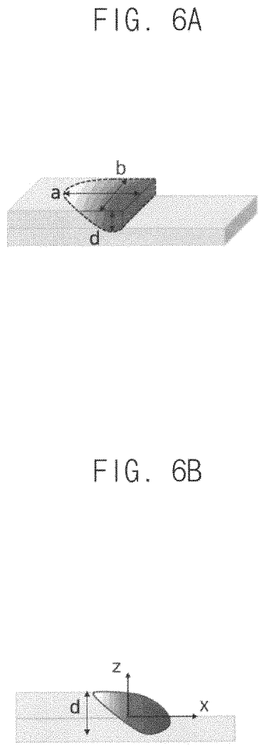

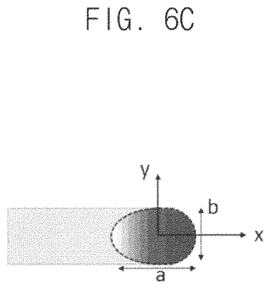

FIG. 6A is a model for predicting a molten pool temperature distribution, which is a schematic diagram showing the length, width, and depth of a molten pool formed on a base material, and FIGS. 6B and 6C are views showing cross-sectional and plan views of the molten pool.

As shown in FIGS. 6A to 6C, in the area seen from the surface of the molten pool 2 by the temperature interface 3 that exceeds the melting point in the molten pool 2, the maximum lengths in the x-axis direction and in the y-axis direction may be defined as the length, a, of the molten pool 2 and the width, b, of the molten pool 2. In addition, although not measured through the surface temperature, the depth in the z-axis direction of the molten pool 2 that can be estimated by the control unit 80 based on the length, a, and width, b, of the molten pool 2 may be defined as d.

Here, the length a and width b of the molten pool 2 may be obtained based on the temperature interface 3 exceeding the melting point of the base material. The length a and width b of the molten pool 2 thus determined may be entered into a pre-set temperature distribution prediction model of the molten pool 2 to derive a temperature distribution Equation 1 of the molten pool 2.

$$T ( x , y , z ) = \frac{{I}_{0}}{2 π K} {\int }_{x = - \frac{1}{2} a}^{x = \frac{1}{2} a} {\int }_{y = 0}^{y = a \sqrt{1 - \frac{{x}^{2}}{{b}^{2}}}} \frac{1}{R} exp ( - \frac{{x}^{2} + {y}^{2}}{{σ}^{2}} ) \times exp ( - \frac{V ( R + x )}{2 α} ) dxdy \qquad ( 1 )$$

Here, K is thermal conductivity of the base material, and Io is intensity scale factor. R=\sqrt{x²+y²+z²}. V is a scanning velocity of the thermal imaging camera 70 when the thermal imaging camera 70 takes the thermal images of the surface of the base material, and Tm is a melting point of the base metal.

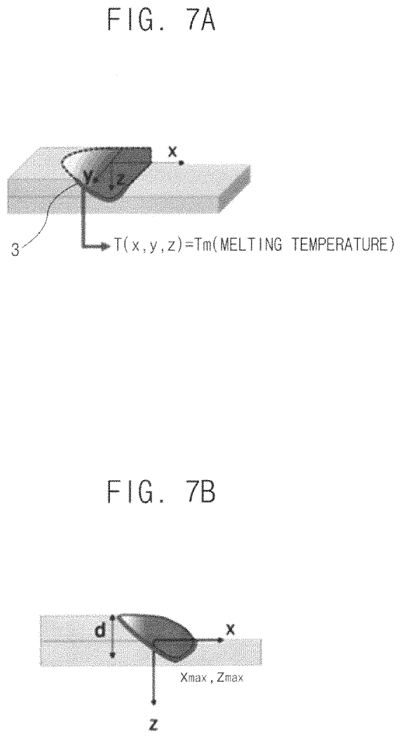

Through the temperature distribution equation of the molten pool 2 thus derived, the boundary surface 3 of the melting point of the molten pool 2 may be set as T(x, y, z)=Tm, as shown in FIG. 7A.

Then, it can be expressed as the following equation.

Φ=T(x,y,z)−Tm (2)

Assuming that the maximum depth of the molten pool 2 is at the center in the width direction of the molten pool 2 of the laminated printing object 4, the y-axis coordinate value corresponding to the maximum depth of the molten pool 2 may be set to 0.

When y=0, Equation (2) can be written as follows.

Φ=T(x,y=0,z)−Tm (3)

In the case of y=0, when Equation (3) is differentiated in the x-axis direction, the differential value of (at the maximum depth point of the molten pool 2 will be 0 and can be written as follows.

$$\frac{\partial φ}{\partial x} = 0 \qquad ( 4 )$$

The point at which the gradient in the x-axis direction is 0 may be defined as a point (Xmax, Zmax) in the x-axis direction as shown in FIG. 7B. Here, the value of Zmax can be estimated as the depth of the molten pool 2 (S14).

It can be confirmed whether the estimated depth of the molten pool 2 is the same as the actual depth of the molten pool 2. To this end, the actual laminated printing object 4 may be cut and the length of the cross section may be measured to know the actual depth of the molten pool 2. It is possible to verify the validity of the estimated depth value of the molten pool 2 by comparing the measured actual depth of the molten pool 2 and the estimated depth of the molten pool 2.

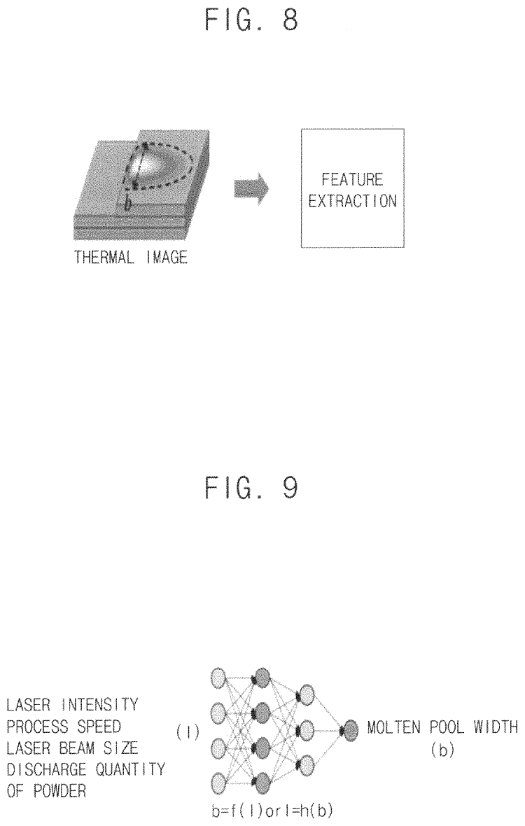

Based on the length and width of the molten pool 2 measured by the thermal imaging camera 70 and the estimated depth of the molten pool 2, a feature of the molten pool 2 such as the size of the molten pool 2 may be extracted as shown in FIGS. 7A, 7B, and 8 (S15).

The control unit 80 may repeat the process of extracting the feature of the molten pool 2 such as the size of the molten pool 2 as described above, and analyze the correlation between the 3D printing process variables used for 3D printing and the feature of the molten pool 2. Based on the data of the correlation obtained as above, the control unit 80 may build an artificial neural network model for predicting the size of the molten pool (S20).

FIG. 9 illustrates analyzing a correlation between process variables and sizes of molten pools using machine learning.

With reference to FIG. 9, in an embodiment of the present disclosure, machine learning may be used to analyze a correlation between the 3D printing process variables and the molten pool. In the 3D printing system 1, the control unit 80 may use the process variable data for 3D printing as input data for a machine learning algorithm and perform machine learning with the input data. Through the machine learning, the control unit 80 may build a build a specific artificial neural network model by which the length (a), width (b), and depth (d) of the molten pool 2 can be predicted when a process variable data is given as an input data.

Specifically, the control unit 80 repeatedly learns the size data of the molten pool 2 based on the measured temperature of the molten pool 2 under the process parameters described above. And based on the data accumulated through the iterative learning, the control unit 80 may derive an artificial neural network model by analyzing the correlation between the process variable and the size of the molten pool 2. The machine learning algorithm for performing such machine learning may be a known algorithm or a dedicated algorithm made for the present disclosure.

In an embodiment of the present disclosure, process variables for 3D printing applied to the machine learning may include the intensity of the laser beam, the process speed, the size of the laser beam, and the ejection amount of the base powder. The process variables applied to the machine learning are not limited thereto.

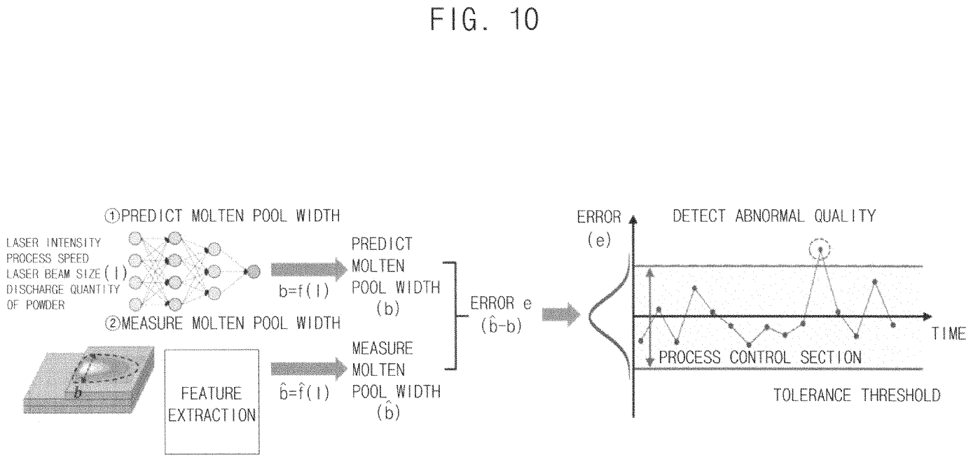

FIG. 10 illustrates a real-time monitoring process through error analysis between a predicted value of size and a measured value of size.

With reference to FIG. 10, after building the artificial neural network model in the control unit 80 through such repetitive learning, the step of calculating an error between the predicted size of the molten pool 2 using the artificial neural network model and the actually measured size of the molten pool 2 is performed (S30). In detail, in step S30 of calculating the error, a predicted size of the molten pool 2 may be derived from a newly measured thermal image by inputting the current process variables into the artificial neural network model (S31). The actually measured size of the molten pool 2 may be obtained based on the surface temperature of the molten pool measured using a thermal imaging camera 70 (S32). The error can be calculated by comparing the predicted size and the actually measured size of the molten pool 2 (S33).

In an example embodiment, the error between the predicted size and the actually measured size of the molten pool 2 may be used as a criterion for determining the quality abnormality of the molten pool 2. That is, in the control unit 80 a criterion for the error between the predicted size of the molten pool 2 and the measured size of the molten pool 2, for example, a tolerance threshold (allowable error threshold) may be set. When an error exists within the tolerance threshold, it is determined that a predetermined quality criterion for the 3D printing process is satisfied, and thus the 3D printing process may be continued.

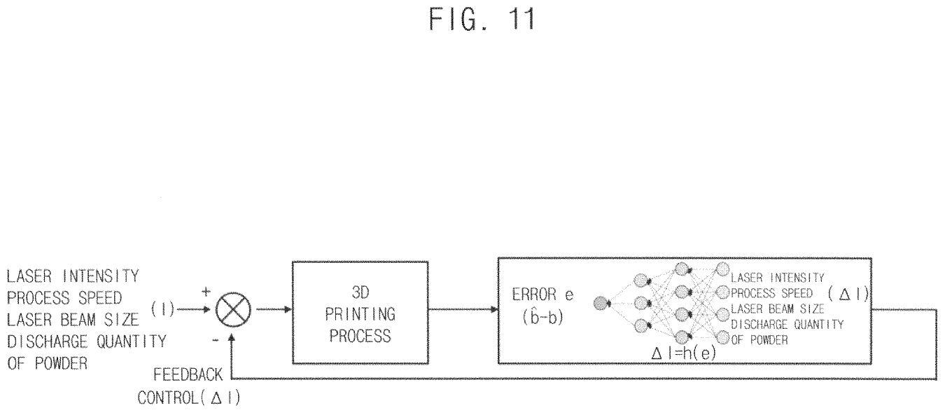

If the error exceeds the tolerance threshold, it may be determined that quality abnormality of 3D printing has occurred (S41). If it is determined that quality abnormality has occurred, real-time feedback control for the 3D printing process may be performed as shown in FIG. 11 (S42). Through the feedback control, the process variable may be adjusted in real time so that the error can fall within the tolerance threshold (S43).

In an example embodiment, the process variable to be controlled may be automatically selected by the control unit 80 in consideration of the correlation, learned based on the artificial neural network model, between the process variable and the size data of the molten pool 2. And, the control of the process variable may be repeatedly performed until the error does not exceed the tolerance threshold.

In the example embodiment described above, it is exemplified that a case in which the error exceeds the tolerance threshold is determined as the quality abnormality and the process variable is adjusted through feedback control. However, when the error does not exceed the tolerance threshold but reaches a risk level near the tolerance threshold, it may be possible to control the process variable in advance so as not to exceed the tolerance threshold.

As described above, in the method according to the embodiments of the present disclosure the actual size of the molten pool 2 may be measured in real time during the 3D printing process using the thermal imaging camera 70. The size of the molten pool 2 may be predicted through a machine-learned artificial neural network model by analyzing the correlation between the process variable and the size of the molten pool 2. Then, it is determined whether or not an abnormality occurs in the size of the molten pool 2 by using the error between the actual measured size of the molten pool 2 and the predicted size of the molten pool 2. Based on the determination result, the size of the molten pool 2 is feedback-controlled. The method for controlling the size of the molten pool 2 may perform the process control in real time while controlling the 3D printing process variable in real time, thereby increasing quality of the 3D printing object and process efficiency.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present disclosure. Accordingly, all such modifications are intended to be included within the scope of the present disclosure as defined in the claims.

What is claimed is:

1. A method of controlling a size of a molten pool formed during a 3D printing process in real time, including:
taking a thermal image of the molten pool formed during the 3D printing process with a thermal imaging camera;
specifying a temperature interface exceeding a melting point of a base metal in the thermal image representing a surface temperature of the molten pool;
obtaining a size of the molten pool by estimating a length, a width, and a depth of the molten pool using the temperature interface;
constructing an artificial neural network model configured to predict a size of the molten pool according to input values of process variables by machine-learning correlation between the process parameters for 3D printing, including intensity of laser beam, process speed, size of the laser beam, and ejection amount of the base material, and the size of the molten pool including length, width, and depth of the molten pool;
deriving, using the artificial neural network model, a predicted value of the size of the molten pool corresponding to the values of process variables currently applied in the currently measured thermal image;
deriving a measured value of a size of an actual molten pool from a surface temperature of the molten pool currently measured by using the thermal imaging camera;
calculating an error between the predicted value of the size of the molten pool using the artificial neural network model and the measured value of the size of the actual molten pool; and
controlling the size of the molten pool in real time by adjusting the values of the processing variables so that the calculated error does not exceed a tolerance threshold.

2. The method of claim 1, wherein the process variables whose values are adjusted in the ‘controlling the size of the molten pool’ are automatically selected based on a correlation between the process variables acquired by the machine-learning and the size of the molten pool.

3. The method of claim 1, wherein the controlling the size of the molten pool by adjusting the values of the process variables is repeatedly performed until the error does not exceed the tolerance threshold.

4. The method of claim 1, wherein the depth of the molten pool is estimated based on the length and width of the molten pool.

5. The method of claim 4, wherein the estimated maximum depth (d) of the molten pool is determined by a z-axis coordinate value (Zmax) at a point (Xmax, 0, Zmax) where a derivative in length direction of a temperature relation, Φ=T(x, y=0, z)−Tm, of the molten pool is 0, where T(x, y=0, z) is a temperature of the molten pool when assuming that the maximum depth (d) point of the molten pool is located at a center (y=0) in a width direction (y-axis direction) of the molten pool.

6. The method of claim 1, wherein the ‘controlling the size of the molten pool’ includes: detecting abnormal quality based on whether the calculated error exceeds the tolerance threshold; feed-backing the calculated error in real-time when abnormal quality is detected; and adjusting the process variables of 3D printing through the real-time feedback.

7. The method of claim 1, wherein the 3D printing process is a 3D printing process based on direct energy deposition (DED) method.

8. The method of claim 1, wherein the base material of the molten pool is a metal material.

9. A 3D printing system, comprising:
a laser source configured to form a molten pool in a laminated 3D object by irradiating a laser beam to melt the base material supplied to the laminated 3D object;
a base material supply source configured to supply a base material to the laminated 3D object;
a thermal imaging camera configured to take a thermal image of the molten pool to measure a surface temperature of the molten pool; and
a control unit configured to control a size of the molten pool formed during a 3D printing process in real time, including the functions of taking a thermal image of the molten pool formed during the 3D printing process with a thermal imaging camera; specifying a temperature interface exceeding a melting point of a base metal in the thermal image representing a surface temperature of the molten pool; obtaining a size of the molten pool by estimating a length, a width, and a depth of the molten pool using the temperature interface; constructing an artificial neural network model configured to predict a size of the molten pool according to input values of process variables by machine-learning correlation between the process parameters for 3D printing, including intensity of laser beam, process speed, size of the laser beam, and ejection amount of the base material, and the size of the molten pool including length, width, and depth of the molten pool; deriving, using the artificial neural network model, a predicted value of the size of the molten pool corresponding to the values of process variables currently applied in the currently measured thermal image; deriving a measured value of a size of an actual molten pool from a surface temperature of the molten pool currently measured by using the thermal imaging camera; calculating an error between the predicted value of the size of the molten pool using the artificial neural network model and the measured value of the size of the actual molten pool; and controlling the size of the molten pool in real time by adjusting the values of the processing variables so that the calculated error does not exceed a tolerance threshold.

10. The 3D printing system of claim 9, wherein the thermal imaging camera is disposed such that at least a part of an optical path of the thermal imaging camera is coaxially with a laser beam irradiated from the laser source that melts a base material supplied to the laminated printing object.

11. The 3D printing system of claim 10, further comprising a beam splitter disposed on a beam path irradiated from the laser source; and an optical path converter disposed between the beam splitter and the thermal imaging camera to change a path of light, wherein the thermal imaging camera is disposed coaxially with the laser source.

12. The 3D printing system of claim 11, wherein the beam splitter is disposed between the laser source and a focus lens through which laser beam emitted from the laser source passes.

13. The 3D printing system of claim 9, wherein the depth of the molten pool is estimated from the obtained length and width of the molten pool.

14. The 3D printing system of claim 13, wherein the estimated maximum depth (d) of the molten pool is determined by a z-axis coordinate value (Zmax) at a point (Xmax, 0, Zmax) where a derivative in length direction of a temperature relation, Φ=T(x, y=0, z)−Tm, of the molten pool is 0, where T(x, y=0, z) is a temperature of the molten pool when assuming that the maximum depth (d) point of the molten pool is located at a center (y=0) in a width direction (y-axis direction) of the molten pool.

15. The 3D printing system of claim 9, wherein the control unit automatically selects process variables to be adjusted so that the calculated error does not exceed the tolerance threshold based on the correlation between the process variables learned by the machine learning and the size of the molten pool.

16. The 3D printing system of claim 9, wherein the control unit repeatedly performs controlling the size of the molten pool by adjusting values of the process variables until the calculated error does not exceed the tolerance threshold.
